(19) United States
(12) Patent Application Publication
(10) Pub. No.: US 2018/0120473 A1
(43) Pub. Date: May 3, 2018

(54) PRESSURE BALANCED LIQUID SCINTILLATOR FOR DOWNHOLE GAMMA DETECTION

(71) Applicant: Halliburton Energy Services, Inc., Houston, TX (US)

(72) Inventor: Robert Jonathan Cull, Newtown, Gloucestershire (GB)

(21) Appl. No.: 15/568,940

(22) PCT Filed: Jun. 3, 2015
(86) PCT No.: PCT/US2015/033922

§ 371 Date: Oct. 24, 2017

(51) Int. Cl. G01V 5/04; G01T 1/204; E21B 47/01; E21B 49/00

(52) U.S. Cl. CPC G01V 5/04; E21B 49/00; E21B 47/011; G01T 1/204

(57) ABSTRACT

An example downhole tool comprises a tool body and a light sensor coupled to the tool body. A scintillator may be coupled to the light sensor and comprise a vessel containing a liquid scintillator. A piston may be in fluid communication with the liquid scintillator and with at least one of an inner surface and an outer surface of the tool body.

### BACKGROUND

The present disclosure relates generally to well drilling operations and, more particularly, to downhole gamma ray detection.

Hydrocarbons, such as oil and gas, are commonly obtained from subterranean formations that may be located onshore or offshore. The development of subterranean operations and the processes involved in removing hydrocarbons from a subterranean formation are complex. Typically, subterranean operations involve a number of different steps such as, for example, drilling a wellbore at a desired well site, treating the wellbore to optimize production of hydrocarbons, and performing the necessary steps to produce and process the hydrocarbons from the subterranean formation. Downhole measurement are typically generated throughout the process. Example measurements include, but are not limited to, resistivity, gamma ray, sonic, nuclear magnetic resonance, and seismic measurements.

Scintillators can be used to generate the downhole gamma ray measurements. They typically include a solid scintillating crystal that interacts with the gamma radiation produced by a subterranean formation to produce photons. Solid scintillator crystals, however, are sensitive to harsh downhole conditions, including temperature, pressure, vibration, and torque, that can cause the crystal to crack or reduce its effectiveness in sensing gamma radiation. Liquid scintillators can also be used, but while the liquid scintillators are not prone to cracking, they are sensitive to downhole temperatures and pressures.

### BRIEF DESCRIPTION OF THE DRAWING(S)

Some specific exemplary embodiments of the disclosure may be understood by referring, in part, to the following description and the accompanying drawings.

FIG. 1 is a diagram of an example subterranean drilling system, according to aspects of the present disclosure.

FIG. 2 is a diagram of an example subterranean drilling system with the drill string removed, according to aspects of the present disclosure.

FIG. 3 is a diagram of an example downhole tool containing a pressure-balanced liquid scintillator, according to aspects of the present disclosure.

FIG. 4 is a diagram of another example downhole tool containing a pressure-balanced liquid scintillator, according to aspects of the present disclosure.

FIG. 5 is a diagram of another example downhole tool containing a pressure-balanced liquid scintillator, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION OF THE DISCLOSURE

Illustrative embodiments of the present disclosure are described in detail herein. In the interest of clarity, not all features of an actual implementation may be described in this specification. It will of course be appreciated that in the development of any such actual embodiment, numerous implementation-specific decisions are made to achieve the specific implementation goals, which will vary from one implementation to another. Moreover, it will be appreciated that such a development effort might be complex and time-consuming, but would, nevertheless, be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like. “Measurement-while-drilling” (“MWD”) is the term generally used for measuring conditions downhole concerning the movement and location of the drilling assembly while the drilling continues. “Logging-while-drilling” (“LWD”) is the term generally used for similar techniques that concentrate more on formation parameter measurement. Devices and methods in accordance with certain embodiments may be used in one or more of wireline (including wireline, slickline, and coiled tubing), downhole robot, MWD, and LWD operations.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processor or processing resource such as a central processing unit (CPU) or hardware or software control logic, ROM, and/or other types of nonvolatile memory. As used herein, a processor may comprise a microprocessor, a microcontroller, a digital signal processor (DSP), an application specific integrated circuit (ASIC), or any other digital or analog circuitry configured to interpret and/or execute program instructions and/or process data for the associated tool or sensor. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

The terms “couple” or “couples” as used herein are intended to mean either an indirect or a direct connection. Thus, if a first device couples to a second device, that connection may be through a direct connection, or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections. Finally, the term “fluidically coupled” as used herein is intended to mean that there is either a direct or an indirect fluid flow path between two components.

According to aspects of the present disclosure, a pressure-balanced liquid scintillator may be used in a downhole environment as a gamma ray detector. As used herein, a liquid scintillator may comprise a liquid solution of one or more types of scintillating crystals, e.g., NaI or halide crystal, and a solvent. As will be described in detail below, the pressure-balanced liquid scintillator may include vessel at least partially filled with a liquid scintillator, and at least one mechanism that facilitates pressure-balancing between the liquid scintillator and fluids in the downhole environment, e.g., drilling fluids in a borehole. The pressure balancing mechanism may allow thermal expansion and contraction of the scintillation fluid which, if kept rigidly confined, would lead to stress in the vessel. The pressure balancing mechanism may also serve to prevent collapse of the vessel by maintaining the scintillation fluid at the same pressure as the drilling mud. This may allow for an associated decrease in the thickness of the vessel, and an increase in the sensitivity of the scintillator by allowing more gamma radiation to reach the liquid scintillator within the tube.

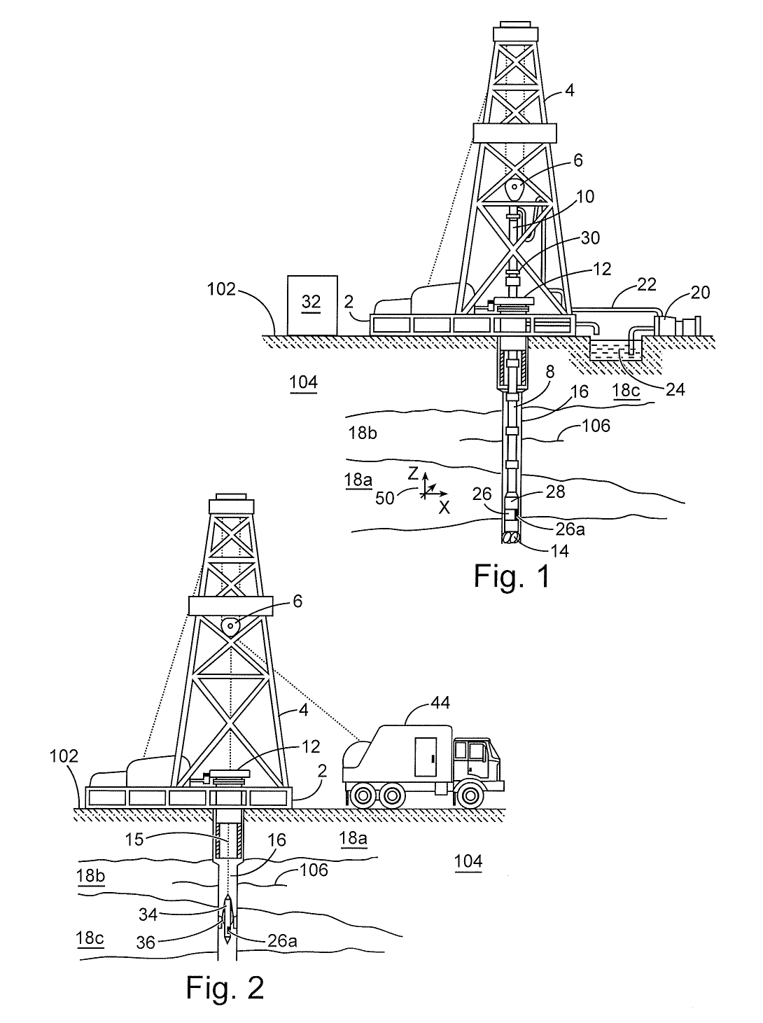

FIG. 1 is a diagram of a subterranean drilling system 80, according to aspects of the present disclosure. The drilling system 80 comprises a drilling platform 2 positioned at the surface 82. In the embodiment shown, the surface 82 comprises the top of a formation 18 containing one or more rock strata or layers 18a-c, and the drilling platform 2 may be in contact with the surface 82. In other embodiments, such as in an off-shore drilling operation, the surface 82 may be separated from the drilling platform 2 by a volume of water.

The drilling system 80 comprises a derrick 4 supported by the drilling platform 2 and having a traveling block 6 for raising and lowering a drill string 8. A kelly 10 may support the drill string 8 as it is lowered through a rotary table 12. A drill bit 14 may be coupled to the drill string 8 and driven by a downhole motor and/or rotation of the drill string 8 by the rotary table 12. As bit 14 rotates, it creates a borehole 16 that passes through one or more rock strata or layers 18. A pump 20 may circulate drilling fluid through a feed pipe 22 to kelly 10, downhole through the interior of drill string 8, through orifices in drill bit 14, back to the surface via the annulus around drill string 8, and into a retention pit 24. The drilling fluid transports cuttings from the borehole 16 into the pit 24 and aids in maintaining integrity or the borehole 16.

The drilling system 80 may comprise a bottom hole assembly (BHA) coupled to the drill string 8 near the drill bit 14. The BHA may comprise various downhole measurement tools and sensors and LWD/MWD elements 26. As the bit extends the borehole 16 through the formations 18, the LWD/MWD elements 26 may collect measurements relating to borehole 16. The LWD/MWD elements 26 may comprise downhole instruments, including sensors, that continuously or intermittently monitor downhole conditions, drilling parameters, and other formation data. The sensors may include, for example, antennas, accelerometers, magnetometers, and gamma ray sensors. In the embodiment shown, one of the sensors of the LWD/MWD elements 26 is a pressure-balanced liquid scintillator 26a, embodiments of which will be described in detail below. The BHA and/or LWD/MWD elements 26 may comprise one or more information handling systems (not shown) that issue commands to the sensors and tools and receive measurements from the tools.

The LWD/MWD elements 26 may be communicably coupled to a telemetry element 28 within the BHA. The telemetry element 28 may transfer measurements from LWD/MWD elements 26 to a surface receiver 30 and/or to receive commands from the surface receiver 30 via a surface information handling system 32. The telemetry element 28 may comprise a mud pulse telemetry system, and acoustic telemetry system, a wired communications system, a wireless communications system, or any other type of communications system that would be appreciated by one of ordinary skill in the art in view of this disclosure. In certain embodiments, some or all of the measurements taken at the LWD/MWD elements 26 may also be stored within the LWD/MWD elements 26 or the telemetry element 28 for later retrieval at the surface 82 by the surface information handling system 32. The surface information handling system 32 may process the measurements to determine characteristics of the formation 18, the borehole 16, or the drilling assembly.

At various times during the drilling process, the drill string 8 may be removed from the borehole 16 as shown in FIG. 2. Once the drill string 8 has been removed, measurement/logging operations can be conducted using a wireline tool 34, i.e., an instrument that is suspended into the borehole 16 by a cable 15 having conductors for transporting power to the tool from a surface power source, and telemetry from the tool body to the surface 102. The wireline tool 34 may comprise measurement and logging elements 36, similar to the LWD/MWD elements 26 described above, including antennas, accelerometers, magnetometers, and gamma ray sensors, such as pressure-balanced liquid scintillator 36a. The elements 36 may be communicatively coupled to the cable 15. A logging facility 44 (shown in FIG. 2 as a truck, although it may be any other structure) may collect measurements from the tool 36, and may include computing facilities (including, e.g., a control unit/information handling system) for controlling, processing, storing, and/or visualizing the measurements gathered by the elements 36. The computing facilities may be communicatively coupled to the elements 36 by way of the cable 15. In certain embodiments, the surface information handling system 32 may serve as the computing facilities of the logging facility 44.

As described earlier, scintillators can be used during drilling or logging operations to generate the downhole gamma ray measurements. Generally, scintillators function by emitting photons when contacted by gamma radiation from a source, such as a subterranean formation. The emitted photons are then detected and counted, and used to identify a characteristic of the radiation source. Typical scintillators are solid crystals that are prone to cracking due to harsh downhole pressure and temperature conditions, as well as the torque and vibration inherent to the drilling process. These problems generally dictate the use of smaller scintillators, which are less able to detect gamma radiation. Liquid scintillators will not crack, allowing a greater volume to be used compared to solid crystals, but the expansion and contraction of the liquid scintillator can require the use of a relatively thick vessel for the liquid scintillator than can reduce the amount of gamma radiation that reaches the liquid scintillator. Balancing the pressure of the liquid scintillator with the pressure of the surrounding drilling fluid in a downhole drilling environment may reduce the stress imparted on the vessel by the pressure of the surrounding drilling fluid, allowing for a less robust, thinner vessel to be used. This may allow more gamma radiation to reach the liquid scintillator, thereby increasing the sensitivity of the scintillator and the accuracy of the gamma measurements.

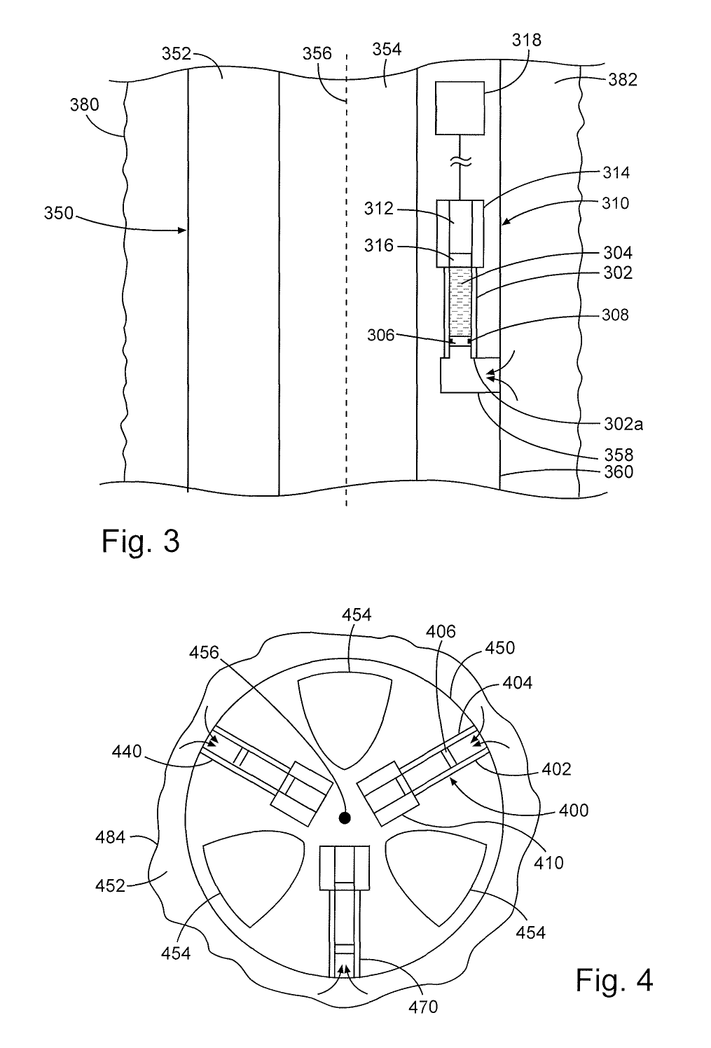

According to aspects of the present disclosure, FIG. 3 is a diagram of an example pressure-balanced liquid scintillator 300 coupled to a downhole tool 350, according to aspects of the present disclosure. The pressure-balanced scintillator 300 comprises a vessel 302 at least partially filled with a liquid scintillator 304. In the embodiment shown, the vessel 302 comprises a scintillator tube that may be made of, for example, a high strength nickel alloy such as Inconel or Incoloy, a high strength steel such as Nitronic 50/60, stainless steel 17-4PH or P550 or a high strength titanium alloy such as 6Al-4V. Other shapes and volumes of vessels are possible, however, as are vessel made from different materials than the ones identified above. A piston 306 is at least partially positioned within the tube 302, and in fluid communication with the liquid scintillator 354. The piston 306 comprises at least one seal 308 that seals an annulus between the piston 306 and an inner surface of the tube 302, at least partially maintaining the liquid scintillator 304 within the tube 302.

In the embodiment shown, a light sensor 310 is coupled to the pressure-balanced liquid scintillator 300. The light sensor 310 comprises a photomultiplier tube 312 positioned within a photomultiplier tube housing 314. Although a photomultiplier tube is shown, other types of light sensors are possible, including, but not limited to, photocells, PIN diodes, photodiode or a quantum dot graphene-based photon sensors, and one or more Geiger-Müller tubes typically filled with compressed He₃ gas that produces voltage impulses from freed electrons released by the He₃ atoms. The photomultiplier tube housing 314 is coupled to the scintillator tube 304 such that the liquid scintillator 304 is axially aligned with the photomultiplier tube 312 and the liquid scintillator 304 is separated from the photomultiplier tube 312 by a sealed quartz window 316 positioned within the housing 314. In this configuration, the light sensor 310 acts to at least partially maintain the liquid scintillator 304 within the scintillator tube 304. In alternative configurations, such as when a different type of light sensor is used, the scintillator tube 302 may have at least one sealed end to maintain the liquid scintillator 304 within the tube 302. An information handling system 318 is communicably coupled to the light sensor 310 to receive at least one output signal from the light sensor 310 corresponding to occurrences of gamma radiation received at the liquid scintillator 304, as will be described below.

The scintillator 300, light sensor 310, and information handling system 318 may be coupled to a tool body 352 of a downhole tool 350. In the embodiment shown, the downhole tool 350 comprises a LWD/MWD element incorporated into a BHA and positioned within a borehole 380 during a drilling operation. To facilitate the necessary flow of drilling fluid through the downhole tool 350 during the drilling operation, the tool body 352 comprises an annular structure with an inner surface 370 that defines an inner flow bore 354. The scintillator 300, light sensor 310, and information handling system 318 are positioned within the annular structure, with the scintillator 300 arranged in parallel with the longitudinal axis 356 of the tool body 352. This, however, is only one potential configuration, as is the structure of the tool body 352. Notably, wireline tools, such as those discussed with reference to FIG. 2, may use a tool body without an inner flow bore.

In the embodiment shown, an end 302a of the scintillator tube 302 is aligned with a flow port 358. The flow port 358 provides fluid communication through the tool body 352 between the piston 306 and an area outside the tool body 352. Here, the area outside the tool body 352 comprises an annulus 382 between the outer surface of 360 of the tool body 352 and a borehole 380. In other embodiments, the flow port 358 may provide fluid communication with the inner flow bore 354. In a typical drilling operation, the annulus 382 is filled with pressurized drilling fluids and formation fluids that are returning to the surface, and the inner flow bore 354 is filled with similarly pressurized drilling fluids that are being pumped downhole from the surface.

In use, the downhole tool 300 and scintillator 350 may be positioned within the borehole 380 as part of a drilling operation, a wireline logging operation, or a completion operation in which a formation is fractured through a substantially completed borehole. As the scintillator 350 moves within the borehole, the pressure of the liquid scintillator 354 may act on a first side of the piston 306 and the pressure of drilling and formation fluids may act of an opposite side of the piston 306 through the flow port 358. The piston 306 may move axially within the scintillator tube 302 until the pressure on each side of the piston 306 is the same and equilibrium is reached. When the pressure of the drilling and formation fluid changes, as may occur as the downhole tool 350 changes depths within the borehole 380, the pressure balance may be maintained through further axial movement of the piston 306. Although a piston 306 positioned within a scintillator tube 302 is used to maintain pressure balance in FIG. 3, this configuration is not intended to be limiting. For example, in other embodiments, the pressure of the liquid scintillator may be balanced with the pressure of the drilling fluid within the borehole through a piston located outside of the scintillator tube but still in fluid communication with the liquid scintillator through a side or secondary port in the scintillator tube. Additionally, in other embodiments, a piston may not be used at all; rather, the pressure of the liquid scintillator may be balanced with the pressure of the drilling fluid within the borehole via a flexible elastomeric diaphragm, for example, or a metal- or polymer-based flexible bellows arrangement As the downhole tool 350 moves within the borehole 380, the liquid scintillator 304 may receive gamma radiation from the formation surrounding the borehole 380. This received gamma radiation may cause the liquid scintillator 354 to emit light photons that are received at the photomultiplier tube 312 through the window 316. The light photons received at the photomultiplier tube 312 may be converted to spikes in an output electrical signal that is received at the information handling system 318. The information handling system 318 may, in turn, process the output signal to determine a characteristic of the formation, or store the output signal for later retrieval and processing at the surface. In certain embodiments, the characteristic of the formation may comprise the composition of the formation, which may be identified based on the amount of gamma radiation received at the liquid scintillator 304. The storage and/or processing steps performed at the information handling system 318 may be controlled by a set of computer readable instructions or software stored locally at the information handling system 318.

FIG. 4 is a diagram of another example pressure-balanced liquid scintillator 400 coupled to a downhole tool 450, according to aspects of the present disclosure. In the embodiment shown, the pressure-balanced liquid scintillator 400 comprises a similar configuration to the scintillator described above with reference to FIG. 3, including a vessel 402 at least partially filled with a liquid scintillator 404; and a piston 406 at least partially within the vessel 402, and in fluid communication with the liquid scintillator 404 and an annulus 484 between the downhole tool 450 and a borehole 482. The pressure-balanced liquid scintillator 400 differs in FIG. 4, however, in that it is one of three pressure-balanced liquid scintillators 400, 420, and 440 at equal angular intervals around a tool body 452 of the downhole tool 450, and arranged perpendicular to a longitudinal axis 456 of the tool body 452. The perpendicular orientation may provide different directional sensitivity to the gamma ray measurements than a parallel orientation, and the additional pressure-balanced liquid scintillators may increase the azimuthal sensitivity and accuracy of the resulting measurements. To accommodate the perpendicular orientation of the pressure-balanced liquid scintillators 400, 420, and 440, three inner flow channels 454 have been used instead of one central bore.

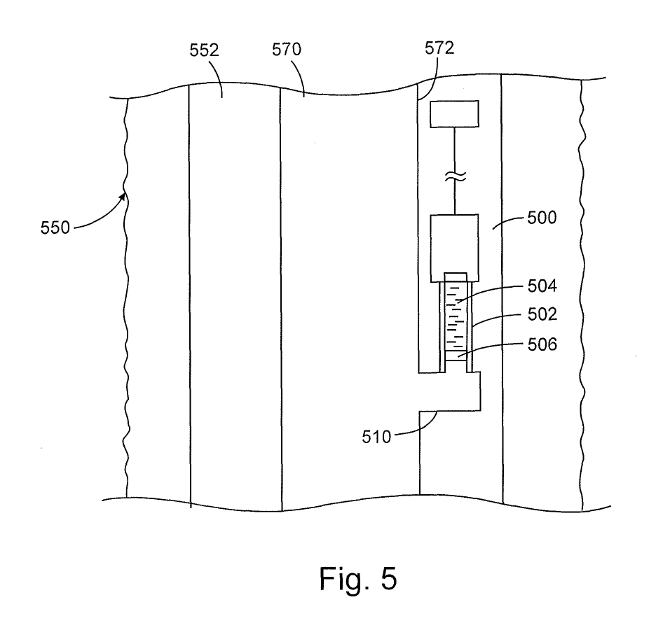

FIG. 5 is a diagram of another example pressure-balanced liquid scintillator 500 coupled to a downhole tool 550, according to aspects of the present disclosure. In the embodiment shown, the pressure-balanced liquid scintillator 500 comprises a similar configuration to the scintillator described above with reference to FIG. 3, including a vessel 502 at least partially filled with a liquid scintillator 504; and a piston 506 at least partially within the vessel 402. In the embodiment shown, however, the piston 506 is in fluid communications with the liquid scintillator 504 and an inner flow bore 570 defined by an inner surface 572 of tool body 552. Specifically, the piston 506 is in fluid communication with the inner flow bore 570 through a port 510 formed in the inner surface 572 of the tool body 552. As mentioned above, the fluid pressure within the inner flow bore 570 may be substantially the same as the fluid pressure surrounding the tool 550 at the same depth. Accordingly, balancing the pressure of the liquid scintillator 504 with the fluid pressure in the inner flow bore 570 may perform substantially the same function as balancing the pressure of the liquid scintillator 504 with the fluid pressure in the annulus surrounding the tool 550.

According to aspects of the present disclosure, an example downhole tool comprises a tool body and a light sensor coupled to the tool body. A scintillator may be coupled to the light sensor and comprise a vessel containing a liquid scintillator. A piston may be in fluid communication with the liquid scintillator and with at least one of an inner surface and an outer surface of the tool body. In certain embodiments, the piston may be at least partially within the vessel. In certain embodiments, the vessel may be arranged axially parallel with the tool body. In certain embodiments, the vessel may be arranged axially perpendicular to the tool body.

In certain embodiments, the tool body may comprise a fluid port through at least one of the inner surface and the outer surface of the tool body, and the piston is in fluid communication with the outer surface of the tool body through the fluid port. In certain embodiments, the scintillator may be one of a plurality of scintillators spaced and equal angular intervals around the tool body.

In any of the embodiments described in the preceding two paragraphs, the light sensor may comprise at least one of a photomultiplier tube, photocells, PIN diodes, photodiode or a quantum dot graphene-based photon sensors, and one or more Geiger-Müller tubes. In any of the embodiments described in the preceding two paragraphs, the liquid scintillator may comprise a liquid solution of one or more types of scintillating crystals and a solvent.

According to aspects of the present disclosure, an example method comprises positioning a scintillator within a borehole in the subterranean formation, wherein the scintillator comprises a vessel containing liquid scintillator. The method may further include balancing a pressure of the liquid scintillator with a pressure of a drilling fluid within the borehole; and receiving an output signal from a light sensor coupled to the vessel. In certain embodiments, balancing the pressure of the liquid scintillator with the pressure of the drilling fluid within the borehole comprises providing a piston in fluid communication with the liquid scintillator and the drilling fluid. In certain embodiments, the piston is at least partially within the vessel. In certain embodiments, positioning the scintillator within the borehole comprises positioning within the borehole a downhole tool to which the scintillator is coupled. In certain embodiments, the scintillator is arranged axially perpendicular to a tool body of the downhole tool. In certain embodiments, the scintillator is arranged axially parallel to a tool body of the downhole tool. In certain embodiments, positioning the scintillator within the borehole comprises positioning within the borehole a downhole tool to which a plurality of scintillators is coupled. In certain embodiments, positioning the scintillator within the borehole comprises positioning within the borehole a downhole tool to which a plurality of scintillators is coupled at equal angularly spaced intervals. In certain embodiments, the downhole tool comprises a tool body, and providing the piston in fluid communication with the liquid scintillator and the drilling fluid the tool body comprises providing the piston in fluid communication with the drilling fluid through a fluid port through at least one of an inner surface and an outer surface of the tool body.

In any of the embodiments described in the preceding paragraph, the method may further comprise determining at least one characteristic of the subterranean formation based, at least in part, on the received output signal. In any of the embodiments described in the preceding paragraph, the method may further comprise at least one of a photomultiplier tube, photocells, PIN diodes, photodiode or a quantum dot graphene-based photon sensors, and one or more Geiger-Müller tubes. In any of the embodiments described in the preceding paragraph, the liquid scintillator may comprise a liquid solution of one or more types of scintillating crystals and a solvent.

Therefore, the present disclosure is well-adapted to carry out the objects and attain the ends and advantages mentioned as well as those which are inherent therein. While the disclosure has been depicted and described by reference to exemplary embodiments of the disclosure, such a reference does not imply a limitation on the disclosure, and no such limitation is to be inferred. The disclosure is capable of considerable modification, alteration, and equivalents in form and function, as will occur to those ordinarily skilled in the pertinent arts and having the benefit of this disclosure. The depicted and described embodiments of the disclosure are exemplary only, and are not exhaustive of the scope of the disclosure. Consequently, the disclosure is intended to be limited only by the spirit and scope of the appended claims, giving full cognizance to equivalents in all respects. The terms in the claims have their plain, ordinary meaning unless otherwise explicitly and clearly defined by the patentee.

What is claimed is:

1. A downhole tool, comprising:
a tool body;
a light sensor coupled to the tool body;
a scintillator coupled to the light sensor and comprising a vessel containing a liquid scintillator; and
a piston in fluid communication with the liquid scintillator and with at least one of an inner surface and an outer surface of the tool body.

2. The downhole tool of claim 1, wherein the piston is at least partially within the vessel.

3. The downhole tool of claim 2, wherein the vessel is arranged axially parallel with the tool body.

4. The downhole tool of claim 2, wherein the vessel is arranged axially perpendicular to the tool body.

5. The downhole tool of claim 2, wherein the tool body comprises a fluid port through at least one of the inner surface and the outer surface of the tool body, and the piston is in fluid communication with the outer surface of the tool body through the fluid port.

6. The downhole tool of claim 1, wherein the scintillator is one of a plurality of scintillators spaced and equal angular intervals around the tool body.

7. The downhole tool of claim 1, wherein the light sensor comprises at least one of a photomultiplier tube, photocells, PIN diodes, photodiode or a quantum dot graphene-based photon sensors, and one or more Geiger-Müller tubes.

8. The downhole tool of claim 1, wherein the liquid scintillator comprises a liquid solution of one or more types of scintillating crystals and a solvent.

9. A method, comprising:
positioning a scintillator within a borehole in the subterranean formation. wherein the scintillator comprises a vessel containing liquid scintillator;
balancing a pressure of the liquid scintillator with a pressure of a drilling fluid within the borehole; and
receiving an output signal from a light sensor coupled to the vessel.

10. The method of claim 9, wherein balancing the pressure of the liquid scintillator with the pressure of the drilling fluid within the borehole comprises providing a piston in fluid communication with the liquid scintillator and the drilling fluid.

11. The method of claim 10, wherein the piston is at least partially within the vessel.

12. The method of claim 10, wherein positioning the scintillator within the borehole comprises positioning within the borehole a downhole tool to which the scintillator is coupled.

13. The method of claim 12, wherein the scintillator is arranged axially perpendicular to a tool body of the downhole tool.

14. The method of claim 12, wherein the scintillator is arranged axially parallel to a tool body of the downhole tool.

15. The method of claim 12, wherein positioning the scintillator within the borehole comprises positioning within the borehole a downhole tool to which a plurality of scintillators is coupled.

16. The method of claim 12, wherein positioning the scintillator within the borehole comprises positioning within the borehole a downhole tool to which a plurality of scintillators is coupled at equal angularly spaced intervals.

17. The method of claim 12, wherein
the downhole tool comprises a tool body; and
providing the piston in fluid communication with the liquid scintillator and the drilling fluid the tool body comprises providing the piston in fluid communication with the drilling fluid through a fluid port through at least one of an inner surface and an outer surface of the tool body.

18. The method of claim 9, further comprising determining at least one characteristic of the subterranean formation based, at least in part, on the received output signal.

19. The method of claim 9, wherein the light sensor comprises at least one of a photomultiplier tube, photocells, PIN diodes, photodiode or a quantum dot graphene-based photon sensors, and one or more Geiger-Müller tubes.

20. The method of claim 9, wherein the liquid scintillator comprises a liquid solution of one or more types of scintillating crystals and a solvent.
